(19) United States
(12) Patent Application Publication
(10) Pub. No.: US 2023/0321579 A1
(43) Pub. Date: Oct. 12, 2023

(54) Filter System and Filter Element

(71) Applicant: MANN+HUMMEL GmbH, Ludwigsburg (DE)

(72) Inventor: Jungmin KANG, Yongin-si (KR)

(21) Appl. No.: 18/180,203

(22) Filed: Mar. 8, 2023

(30) Foreign Application Priority Data
Mar. 28, 2022 (EP) 22164761.3

(51) Int. Cl. B01D 46/00

(52) U.S. Cl. CPC B01D 46/0005; B01D 46/0004; B01D 2275/206

(57) ABSTRACT

A filter system includes a housing comprising a first housing part and a second housing part, a fluid inlet formed in the first housing part, a fluid outlet formed in the second housing part, and a filter element being accommodated in the housing, and comprising a filter body with a filter medium enclosed by a circumferential frame element, and structure elements protruding from a circumference of the filter element, the structure elements comprising grooves respectively in circumference walls of the structure elements. The first housing part comprises a receiving part for receiving the filter element, the receiving part comprising counter elements respectively corresponding to the structure elements, and the counter elements being breakthroughs that are arranged circumferentially on and formed through a wall of the receiving part. The grooves included in the structure elements are for receiving edges of the breakthroughs of the counter elements.

### CROSS-REFERENCE TO RELATED APPLICATION

This application claims the benefit under 35 U.S.C. 119(a) of European Application No. 22164761.3 filed on Mar. 28, 2022, in the European Patent Office, the entire disclosure of which is incorporated herein by reference for all purposes.

### TECHNICAL FIELD

The invention relates to a filter system, in particular an air filter system and to a filter element for a filter system.

### BACKGROUND ART

US 2013/0305930 A1 discloses an air cleaner assembly having improved dynamic wall stiffness includes an air filter element having a filter media for filtering an air stream in the air cleaner. The filter element includes a substantially rigid frame member that surrounds a flow aperture covered by the filter media. Having a frame member, the frame member supports the filter media and has a frame body that circumferentially surrounds the flow aperture. A flange for mounting the filter element in an air cleaner housing is secured to the frame body or otherwise secured to the filter element and extend generally outwardly relative to the flow aperture. To provide further improved dynamically stiffening of the walls of the air cleaner, the filter element is provided with one or more wall stiffening members. The stiffening members include elongated locking members secured and positioned at opposing sidewalls of the filter element. Having a frame member, the locking members are secured onto the frame member and positioned at opposing sidewalls of the filter element. The locking members extend in an axial flow direction at least partially along the depth of the sidewall of the filter element. Having at least one stiffening rib, the substantially rigid elongated stiffening rib extends laterally across the flow aperture proximate to the filter media between the two locking members at the opposing filter sides. The stiffening rib or ribs is secured at opposing ends to a respective one of the locking members.

### SUMMARY

It is an object of the invention to provide a stable filter system, in particular an air filter system, being easily to assemble or disassemble.

Another object is to provide a filter element for a filter system, in particular an air filter system, being easily to assemble or disassemble.

According to an aspect of the invention the first object is achieved by a filter system, in particular an air filter system, comprising a housing, a fluid inlet formed in a first housing part, a fluid outlet formed in a second housing part, a filter element being accommodated in the housing, wherein the filter element comprises a filter body with a filter medium enclosed by a circumferential frame element, wherein one or more structure elements are arranged on a circumference of the filter element, wherein a receiving part is provided on the first housing part for receiving the filter element, the receiving part providing one or more corresponding counter elements for cooperating with the one or more structure elements, the one or more counter elements being arranged circumferentially on a wall of the receiving part, wherein the one or more structure elements and the one or more counter elements form a tight connection when the filter element is arranged in the receiving part.

According to a further aspect of the invention the other object is achieved by a filter element for a filter system, in particular an air filter system, according to any one of the preceding claims, comprising a filter body with a filter medium enclosed by a circumferential frame element, and comprising one or more circumferentially arranged structure elements on a circumference of the filter element, wherein the one or more structure elements are configured to form a tight connection with corresponding one or more counter elements, when in an intended use the filter element is arranged in a receiving part of a first housing part of a housing of the filter system.

Advantageous embodiments are described in the dependent claims, the description and the drawings.

A filter system, in particular an air filter system, is proposed, comprising a housing, a fluid inlet formed in a first housing part, a fluid outlet formed in a second housing part, a filter element being accommodated in the housing, wherein the filter element comprises a filter body with a filter medium enclosed by a circumferential frame element, wherein one or more structure elements are arranged on a circumference of the filter element. A receiving part is provided on the first housing part for receiving the filter element, the receiving part providing one or more corresponding counter elements for cooperating with the one or more structure elements, the one or more counter elements being arranged circumferentially on a wall of the receiving part. The one or more structure elements and the one or more counter elements form a tight connection when the filter element is arranged in the receiving part.

Advantageously the counter elements are complementarily formed to the structure elements. Thus the structure elements and the counter elements are fitting tightly when the filter element is mounted to the first housing part.

By this way, the filter element may easily be mounted to the first housing part and/or easily dismounted for replacement of the filter element.

A further advantage of this design of structure elements and counter elements is that these elements may stiffen the housing when the filter element is mounted to the first housing part. Therefore any stiffening ribs of the housing which may be needed otherwise may be replaced by the cooperation of the structure elements and the counter elements.

Thus according to embodiments of the invention an easy mounting of the filter element into the housing of the filter system together with a stiffened housing may achieved. Also a weight of the filter system may advantageously be reduced by this way.

According to a favorable embodiment of the filter system, the one or more structure elements may be protruding from the circumference of the filter element, and the one or more counter elements may be configured as breakthroughs through the wall of the receiving part.

In this preferred embodiment the counter elements may be realized as slots in a wall of the receiving part, where the structure elements may be inserted when the filter element is mounted to the first housing part. Advantageously the housing is sealed against the environment when the filter element is mounted into the housing as the slots are then closed by the structure elements. Thus no harmful particles or fluids from the environment may enter an inside of the housing.

According to a favorable embodiment of the filter system, the one or more structure elements may comprise grooves in a circumference wall for receiving edges of the one or more counter elements of the wall of the receiving part in a sealing manner, when the filter element is being inserted into the receiving part. By this way, the counter elements and thus the housing may be sealed by the structure elements when the filter element is mounted to the housing.

According to a favorable embodiment of the filter system, the one or more structure elements may be breakthroughs through a side wall arranged at the circumference of the filter element, and the one or more counter elements may be protruding inward from the wall of the receiving part. In this alternative embodiment the counter elements may be inserted into the circumference of the filter element when the filter element is mounted to the housing. Advantageously the housing may be stiffened by the cooperation of the structure elements and the counter elements and also the filter element may be sealed against a raw fluid section of the first housing part.

According to a favorable embodiment of the filter system, the one or more structure elements may be formed with a tapered shape in a mounting direction. Advantageously mounting of the filter element into the first housing part may be facilitated.

According to a favorable embodiment of the filter system, the second housing part may be provided with a protruding edge overlapping the first housing part when mounted on top of the first housing part. By this way easy placement of the second housing part on top of the first housing part is possible as well as reliable sealing of the housing against the environment.

According to a favorable embodiment of the filter system, one or more snap hooks may be provided on the first housing part for tightly closing the housing by fitting into a corresponding groove of the second housing part when the housing is in a closed state. By this way easy mounting of the second housing part on top of the first housing part is possible as well as reliable connection of the first housing part and the second housing part and sealing of the housing against the environment.

According to a favorable embodiment of the filter system the one or more structure elements may be integral with a side wall which at least partially surrounds the filter body. Alternatively or additionally, the one or more structure elements may be integral with the frame element. Advantageously production of the filter system may be optimized due to reduced production cost of the single parts of the filter element and the housing.

Further, a filter element for a filter system, in particular an air filter system, is proposed, comprising a filter body with a filter medium enclosed by a circumferential frame element, and comprising one or more circumferentially arranged structure elements on a circumference of the filter element, wherein the one or more structure elements are configured to form a tight connection with corresponding one or more counter elements, when in an intended use the filter element is arranged in a receiving part of a first housing part of a housing of the filter system.

Advantageously the structure elements are complementarily formed to the counter elements. Thus the structure elements and the counter elements are fitting tightly when the filter element is mounted to the first housing part.

By this way, the filter element may easily be mounted to the first housing part and/or easily dismounted for replacement of the filter element.

A further advantage of this design of structure elements and counter elements is that these elements may stiffen the housing when the filter element is mounted to the first housing part. Therefore any stiffening ribs of the housing which may be needed otherwise may be replaced by the cooperation of the structure elements and the counter elements.

Thus according to embodiments of the invention an easy mounting of the filter element into the housing of the filter system together with a stiffened housing may achieved. Also a weight of the filter system may advantageously be reduced by this way.

According to a favorable embodiment of the filter element, the one or more structure elements may be configured protruding from the circumference of the filter element.

In this preferred embodiment the counter elements may be realized as slots in a wall of the receiving part, where the structure elements may be inserted when the filter element is mounted to the first housing part. Advantageously the housing is sealed against the environment when the filter element is mounted into the housing as the slots are then closed by the structure elements. Thus no harmful particles or fluids from the environment may enter an inside of the housing.

According to a favorable embodiment of the filter element, the one or more structure elements may comprise grooves arranged in a circumference wall. The grooves may advantageously serve for receiving edges of the one or more counter elements of the wall of the receiving part in a sealing manner, when the filter element is being inserted into the receiving part.

According to a favorable embodiment of the filter element, the one or more structure elements may be breakthroughs through a side wall of the filter element. In this alternative embodiment the one or more counter elements may be protruding inward from the wall of the receiving part. Then the counter elements may be inserted into the circumference of the filter element when the filter element is mounted to the housing.

According to a favorable embodiment of the filter element, the one or more structure elements may be formed with a tapered shape in an intended mounting direction. Advantageously mounting of the filter element into the first housing part may be facilitated.

According to a favorable embodiment of the filter element, the one or more structure elements may be integral with a side wall which at least partially surrounds the filter body. Alternatively or additionally, the one or more structure elements may be integral with the frame element. Advantageously production of the filter system may be optimized due to reduced production cost of the single parts of the filter element and the housing.

### BRIEF DESCRIPTION OF DRAWINGS

The present invention together with the above-mentioned and other objects and advantages may best be understood from the following detailed description of the embodiments, but not restricted to the embodiments, wherein is shown in:

FIG. 1 is a filter system with a first housing part and a filter element according to an embodiment of the invention in an exploded view;

FIG. 2 is a detailed view of a structure element of the filter element according to FIG. 1;

FIG. 3 is the filter element according to FIG. 1 during a mounting process into the first housing part;

FIG. 4 is the filter element according to FIG. 1 inserted into the first housing part; and

FIG. 5 is a filter system according to an embodiment of the invention with a filter element inserted and the housing closed.

### DETAILED DESCRIPTION

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

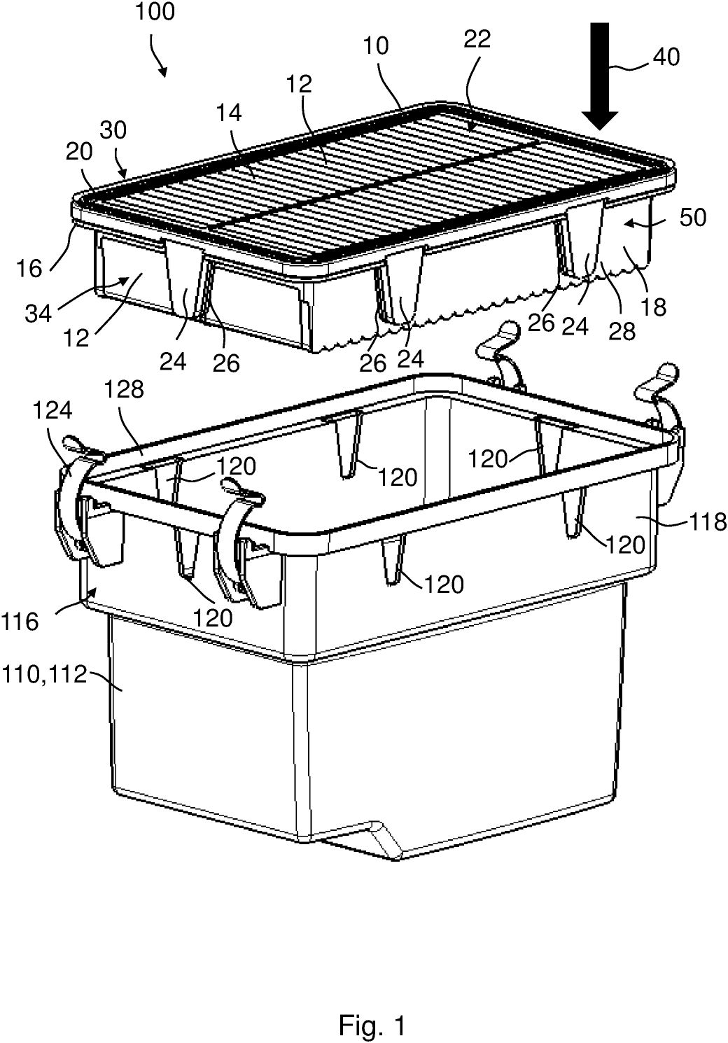

FIG. 1 depicts a filter system 100, in particular an air filter system 100, with a first housing part 112 and a filter element 10 according to an embodiment of the invention in an exploded view.

The filter system 100 comprises a housing 110, where in FIG. 1 only the first housing part 112, which is the lower part of the housing 110, is shown. Further the filter system 100 comprises the filter element 10 which in an intended use is accommodated in the housing 110.

The filter element 10 comprises a filter body 12 with a filter medium 14, e.g. a pleated nonwoven, which is enclosed by a circumferential frame element 16. The frame element 16 supports a gasket 20 between the raw side and the clean side of the filter system 100.

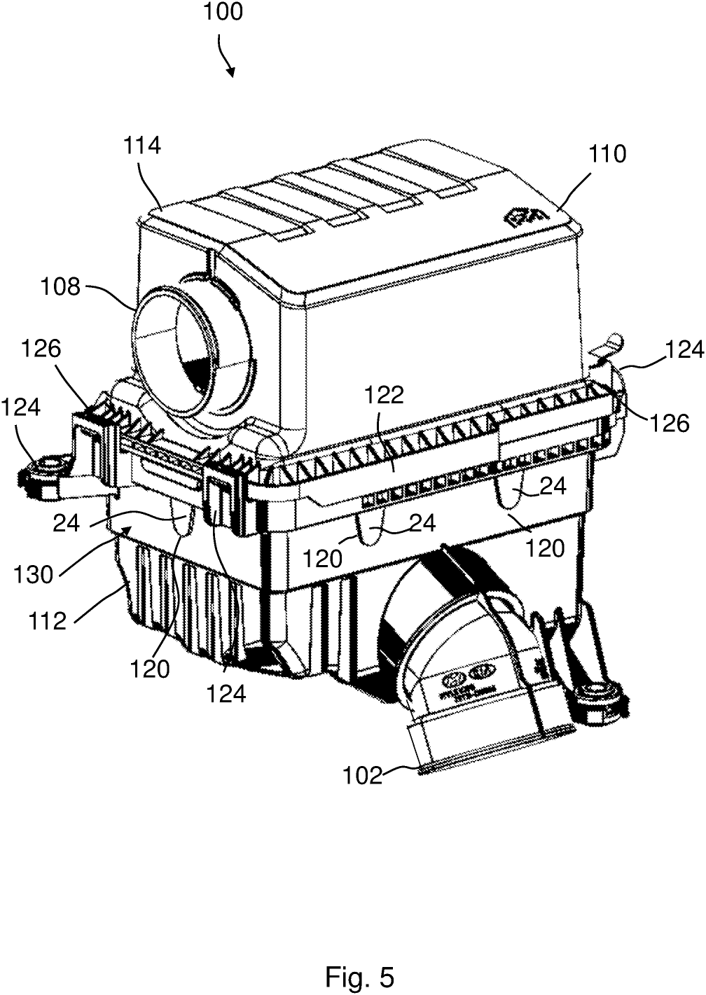

A receiving part 116 is provided on the first housing part 112 for receiving the filter element 10. The frame element 16 fits into a flange 128 of the receiving part 116 when the filter element 10 is mounted to the first housing part 112 so that the gasket 20 of the frame element 16 is received by a sealing surface of a second housing part 114 (FIG. 5) when closing the first housing part 112.

A number of structure elements 24 are arranged on a circumference 50 of the filter element 10, e.g. in a side wall 18 of the circumference 50 and as part of the frame element 16, respectively.

The receiving part 116 provides a number of corresponding counter elements 120 for cooperating with the structure elements 24. The counter elements 120 are arranged circumferentially on a wall 118 of the receiving part 116.

The structure elements 24 and the counter elements 120 form a tight connection when the filter element 10 is arranged in the receiving part 116.

The structure elements 24 are protruding from the circumference 50 of the filter element 10, whereas the counter elements 120 are configured as breakthroughs, e.g. slots, through the wall 118 of the receiving part 116. So the structure elements 24 fit into the counter elements 120 when the filter element 10 is mounted to the first housing part 112.

The structure elements 24 are formed with a tapered shape 28 in a mounting direction 40. This facilitates mounting of the filter element 10 into the first housing part 112 as the structure elements 24 are self-centering in the counter elements 120 when the filter element 10 is moved in the mounting direction 40.

The structure elements 24 are integral with the side walls 18 which at least partially surround the filter body 12. On a front side 34 the structure elements 24 are integral with the frame element 16 because the front side 34 is represented as the filter body 12 in this embodiment. In an alternative embodiment the side walls 18 may be realized on the whole circumference 50.

In an alternative embodiment the structure elements 24 could be breakthroughs through the side wall 18 arranged at the circumference 50 of the filter element 10, and the counter elements 120 could be protruding inward from the wall 118 of the receiving part 116. Such a configuration would also facilitate mounting of the filter element 10 to the first housing part 112 as the counter elements 10 would also fit into the structure elements 24.

The gasket 20 is circumferentially arranged on a top side 30 of the frame element 16 and serves for sealing the raw fluid region inside the housing 110 of the filter system 100 against the filtered fluid region when the housing 110 is closed. The top region 22 of the filter body 12 directs to the filtered fluid region.

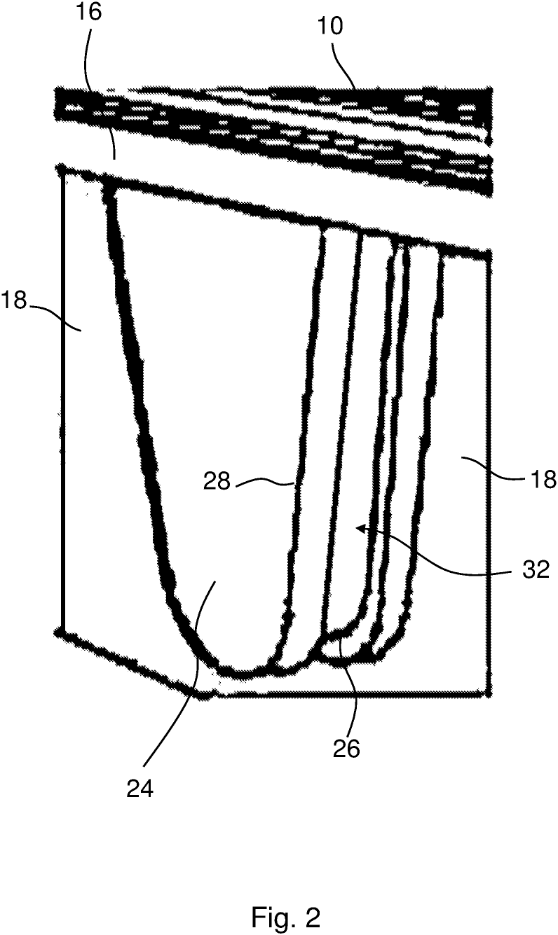

FIG. 2 depicts a detailed view of a structure element 24 of the filter element 10 according to FIG. 1.

As is to be seen the structure elements 24 comprise grooves 26 in a circumference wall 32 for receiving edges of the counter elements 120 of the wall 118 of the receiving part 116 in a sealing manner, when the filter element 10 is being inserted into the receiving part 116. Thus the housing 110 is sealed against the environment when the filter element 10 is inserted into the first housing part 112 and no harmful particles or fluid may enter the housing 110 when the filter element 10 is mounted.

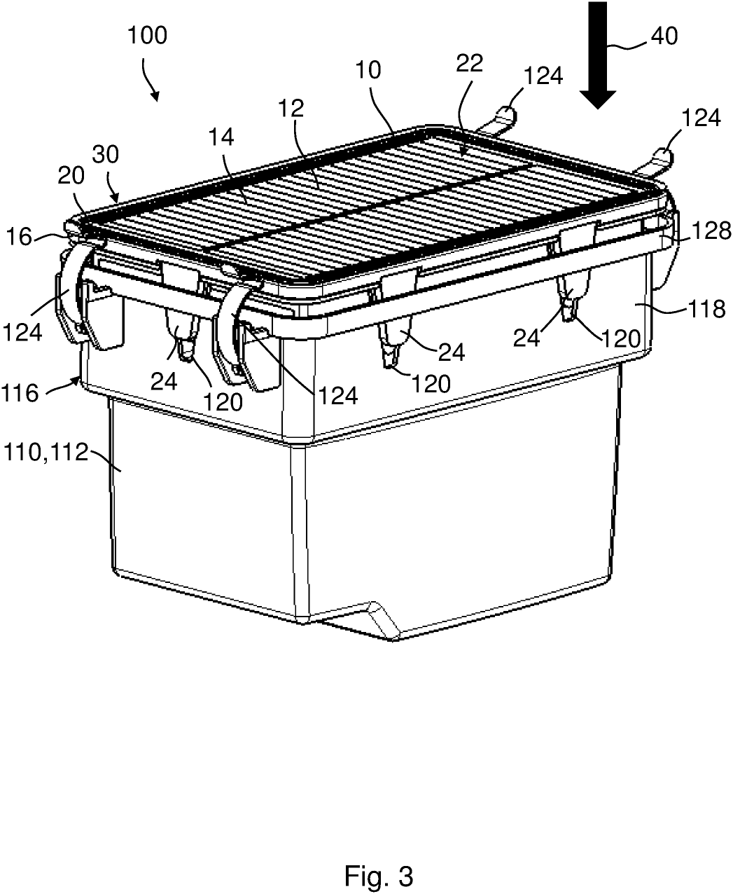

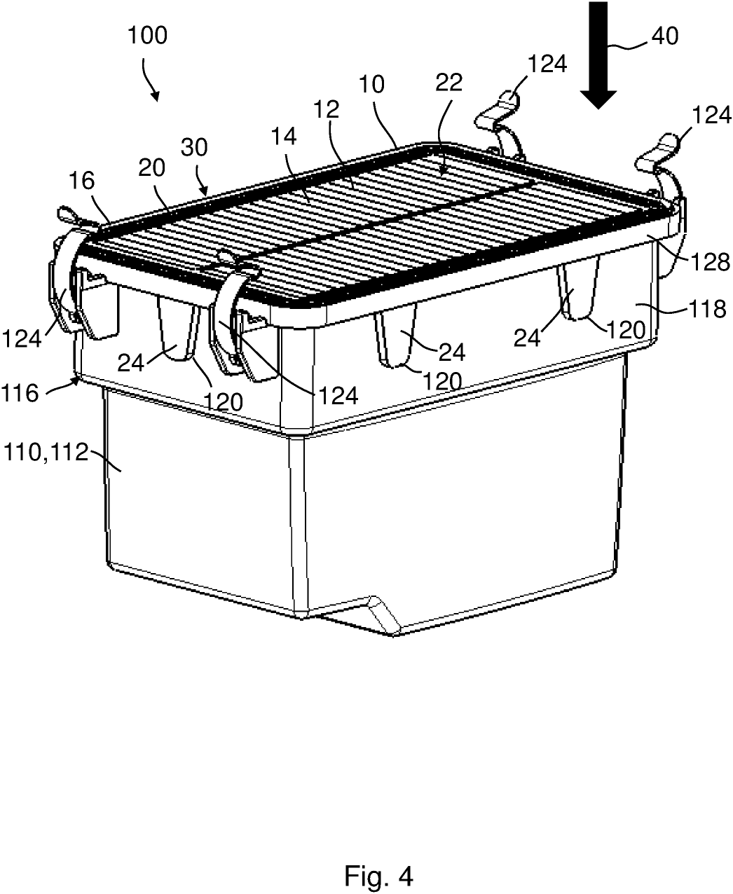

FIG. 3 depicts the filter element 10 according to FIG. 1 during a mounting process into the first housing part 112, whereas in FIG. 4 the filter element 10 is fully inserted into the first housing part 112.

In FIG. 3 the filter element 10 is partly inserted into the first housing part 112. The slots of the counter elements 120 are not yet fully closed by the structure elements 10 of the filter element 10, whereas in FIG. 4 the slots of the counter elements 120 are fully closed by the structure elements 10 of the filter element 10. Thus the housing 110 is sealed against the environment. Advantageously the housing 110 is also stiffened as the structure elements 24 of the filter element 10 also contribute to stiffening of the housing 110 by the close cooperation with the counter elements 120 of the first housing part 112.

In FIG. 5 a filter system 100 according to an embodiment of the invention is depicted with a filter element 10 inserted and the housing 100 closed.

The housing 110 of the filter system 100 comprises the first housing part 112 and the second housing part 114. A fluid inlet 102 is formed in the first housing part 112, a fluid outlet 108 is formed in the second housing part 114.

The second housing part 114 is provided with a protruding edge 122 overlapping the first housing part 112 when mounted on top of the first housing part 112.

Four snap hooks 124, two on each front side 130, are provided on the first housing part 112 for tightly closing the housing 110 by fitting into a corresponding groove 126 of the second housing part 114 when the housing 110 is in a closed state. In FIG. 5 on the front side 130 to be seen in the Figure one snap hook 124 is closed whereas the other snap hook 124 is open.

1. A filter system comprising:
a housing comprising a first housing part and a second housing part;
a fluid inlet formed in the first housing part;
a fluid outlet formed in the second housing part; and
a filter element being accommodated in the housing, and comprising:
a filter body with a filter medium enclosed by a circumferential frame element; and
structure elements protruding from a circumference of the filter element, the structure elements comprising grooves respectively in circumference walls of the structure elements,
wherein the first housing part comprises a receiving part for receiving the filter element, the receiving part comprising counter elements respectively corresponding to the structure elements, and the counter elements being breakthroughs that are arranged circumferentially on and formed through a wall of the receiving part, and
wherein the grooves included in the structure elements are for receiving edges of the breakthroughs of the counter elements in a sealing manner when the filter element is arranged in the receiving part.

2. The filter system according to claim 1, wherein the structure elements are formed with a tapered shape in a mounting direction.

3. The filter system according to claim 1, wherein the second housing part comprises a protruding edge overlapping the first housing part when mounted on top of the first housing part.

4. The filter system according to claim 1, wherein the first housing part further comprises one or more snap hooks for closing the housing by respectively fitting into one or more grooves included in the second housing part.

5. The filter system according to claim 1, wherein the structure elements are integral with a side wall at least partially surrounding the filter body.

6. The filter system according to claim 1, wherein the structure elements are integral with the circumferential frame element.

7. A filter element for a filter system, the filter element comprising:
a filter body with a filter medium enclosed by a circumferential frame element; and
structure elements protruding from a circumference of the filter element, the structure elements comprising grooves respectively in circumference walls of the structure elements, and the grooves being for receiving edges of breakthroughs of counter elements that are arranged circumferentially on and formed through a wall of a receiving part included in the filter system, in a sealing manner when the filter element is arranged in the receiving part.

8. The filter element according to claim 7, wherein the structure elements are formed with a tapered shape in a mounting direction.

9. The filter element according to claim 7, wherein the structure elements are integral with a side wall at least partially surrounding the filter body.

10. The filter element according to claim 7, wherein the structure elements are integral with the circumferential frame element.
